(19) United States
(12) Patent Application Publication
(10) Pub. No.: US 2012/0165995 A1
(43) Pub. Date: Jun. 28, 2012

(54) Slug Countermeasure Systems and Methods

(75) Inventors: Charles M. Crawley, Montgomery, TX (US); Lisa A. Brenskelle, Houston, TX (US)

(73) Assignee: CHEVRON U.S.A. INC., San Ramon, CA (US)

(21) Appl. No.: 12/975,906

(22) Filed: Dec. 22, 2010

(51) Int. Cl. F17D 3/00; G05D 7/00

(52) U.S. Cl. 700/282; 137/8

(57) ABSTRACT

In one embodiment, a method comprising receiving slug attribute information from a distributed or multi-point sensing system coupled to a fluid processing system, the slug attribute information associated with one or more slugs present in the fluid processing system; determining by a processor whether to activate one or more control devices of the fluid processing system to effect slug countermeasures based on the slug attribute information, the slug countermeasures comprising slug control; and activating the one or more control devices responsive to the determination.

### TECHNICAL FIELD

This disclosure relates in general to addressing the presence of slugs in fluid flows.

### DESCRIPTION OF THE RELATED ART

Slug flow is a flow regime for multiphase fluids in which predominantly liquid slugs alternate with predominantly gas slugs. Slug flow is inherently unstable and produces widely varying flow conditions, leading to operational upsets. Slug flow is a feature of multiphase flow systems. Certain conditions, such as low velocity fluid flow, oversized piping, elevation changes in piping where liquids can accumulate and block the piping, and/or operational or other conditions can cause the slugging phenomena to occur. Slug flow is problematic for several reasons. For instance, the alternating, unstable nature of the flow may cause increased wear and tear on process facility equipment. As another example, large slugs may lead to operational upsets, shutdown of facilities and/or environmental violations (e.g., flaring, poor separation of oil and water, etc.). In general, slugging behavior may lead to reduced production for existing process facilities. For new process facilities, separators may be oversized and/or slug catchers installed in anticipation of slugs, often leading to increased capital costs.

### SUMMARY

In one embodiment, a method comprising receiving slug attribute information from a distributed or multi-point sensing system coupled to a fluid processing system, the slug attribute information associated with one or more slugs present in the fluid processing system; determining by a processor whether to activate one or more control devices of the fluid processing system to effect slug countermeasures based on the slug attribute information, the slug countermeasures comprising slug control; and activating the one or more control devices responsive to the determination.

### BRIEF DESCRIPTION OF THE DRAWINGS

The systems and methods described herein can be better understood with reference to the following drawings. The components in the drawings are not necessarily drawn to scale, emphasis instead being placed upon clearly illustrating the principles of the present disclosure. In the drawings, like reference numerals designate corresponding parts throughout the several views.

FIG. 1 is a schematic diagram of an example fluid processing environment in which embodiments of slug countermeasure (SCM) systems and methods may be employed.

FIG. 2 is a block diagram of a portion of the example fluid processing environment illustrating an example SCM control system coupled to an example distributed sensing system.

FIG. 3 is a block diagram of an embodiment of an example SCM control system embodied as a computing device.

FIGS. 4-5 are flow diagrams that illustrate example SCM method embodiments.

### DETAILED DESCRIPTION OF EXAMPLE EMBODIMENTS

Disclosed herein are certain embodiments of slug countermeasure (SCM) systems and methods (herein, collectively referred to also as a slug countermeasure system(s) or SCM system(s)) that receive signals from, among other sources, multiple sensors of respective one or more multi-point (MP) sensor systems and/or from one or more distributed sensing systems that supply slug attribute information, process those signals, and provide slug countermeasures based on the received slug attribute information and/or information from other sources in a fluid processing environment. All or at least a portion of the fluid processing environment may include a flow of multi-phase fluid (e.g., gas, such as well gas, and one or more liquids, such as aqueous-based and/or hydrocarbon-based liquids). Further, slugs may be in a gas (entirely or predominantly gas) or liquid (entirely or predominantly liquid) phase, and both may occur, alternately or concurrently, in a given fluid processing system. Note that slug behavior contemplated to be within the scope of the disclosure includes slugs that exhibit transient behavior (e.g., due to operational conditions, such as a result of start-ups or ramp-ups, among other causes), as well as the more commonly known, continuous or on-going behavior (e.g., due to terrain changes, which are long-term conditions, due to multi-phase flow above a laminar flow regime and below an annular flow regime, etc.) of slugs. It should be understood that one or more embodiments of SCM systems may be applied to address conditions that mimic slug behavior, such as casing heading or density wave behavior, among others.

Slug attribute information may include information enabling a determination of slug and/or slug flow characteristics. Accordingly, slug attribute information may include, without limitation (e.g., not an exhaustive list), one or a combination of the following: slug location, slug length, slug propagation direction, frequency of slug occurrence, slug density, slug temperature, slug composition (e.g., slug salinity), slug velocity (front and/or back, which includes speed in any phase), slug volume (e.g., total and/or fractional, such as by phase), slug pressure, slug level (e.g., if the slug forms in a riser), and/or multiphase flow rate.

Certain embodiments of SCM systems use the slug attribute information as an integral part of an automated control scheme that dynamically employs various slug countermeasures in a fluid processing environment. For instance, slug countermeasures typically fall into two broad categories: slug mitigation and slug control. Slug mitigation generally involves control schemes or devices that lessen the impact of slug flow on processing facilities. In some implementations, slug mitigation is embodied as capacity control of multi-phase fluid separators and downstream equipment. Slug control typically acts to reduce the size of the slug or its frequency and/or duration, or alternatively, eliminate the slug entirely.

As described further below, in certain embodiments of SCM systems disclosed herein, one or a combination of both slug countermeasures may be dynamically employed based on real-time or near real-time receipt of the received slug attribute information and/or possibly other information (e.g., from single point sensors or distributed or multi-point sensor systems that provide other information), enabling an intelligent approach to slug control (e.g., selective throttling of one or more of a plurality of control devices, such as downhole, topside, and/or subsea control valves, variable speed drives and other equipment) and slug mitigation (e.g., capacity control, etc.). Through implementation of intelligent, dynamically-applied slug countermeasures, operational upsets of existing facilities from slug effects may be mitigated or eliminated, and/or future facilities may be designed with reduced-capacity separators (and/or elimination of slug catchers).

These advantages and/or features, among others, are described hereinafter in the context of a fluid processing environment that includes a plurality of control devices (e.g., control valves, controllers, and downstream equipment such as pumps, variable speed drives, compressors, etc.), sensors (e.g., single point, multi-point, and distributed) and one or more multi-phase separators (e.g., two-phase slug catchers and/or three phase separators, such as gas, water, and hydrocarbon-based liquids). Note that in some embodiments, a device may be utilized that merges control and sensing functionality, and hence may be referred to herein as a controller, a control device (with sensing functionality), and as a sensor (with control device functionality). It should be understood that use of the term “separator” herein is intended to generically refer to equipment that attempts to separate phases of fluids, and includes devices of a different name that perform the same or similar functionality, such as slug catchers (two-phase separation), cyclones, and degassers, among others. Further, an SCM system is disclosed that enables slug countermeasures to be performed through interaction with the control devices and sensors, the SCM system in one embodiment including an SCM control system embodied as a computing device, a distributed sensing system and/or multi-point sensing system, and one or more sensors, each communicatively coupled to the SCM control system, as well as control devices. However, it should be appreciated that other system embodiments are contemplated to be within the scope of the disclosure. Further, it should be understood by one having ordinary skill in the art that, though specifics for one or more embodiments are disclosed herein, such specifics as described are not necessarily part of every embodiment.

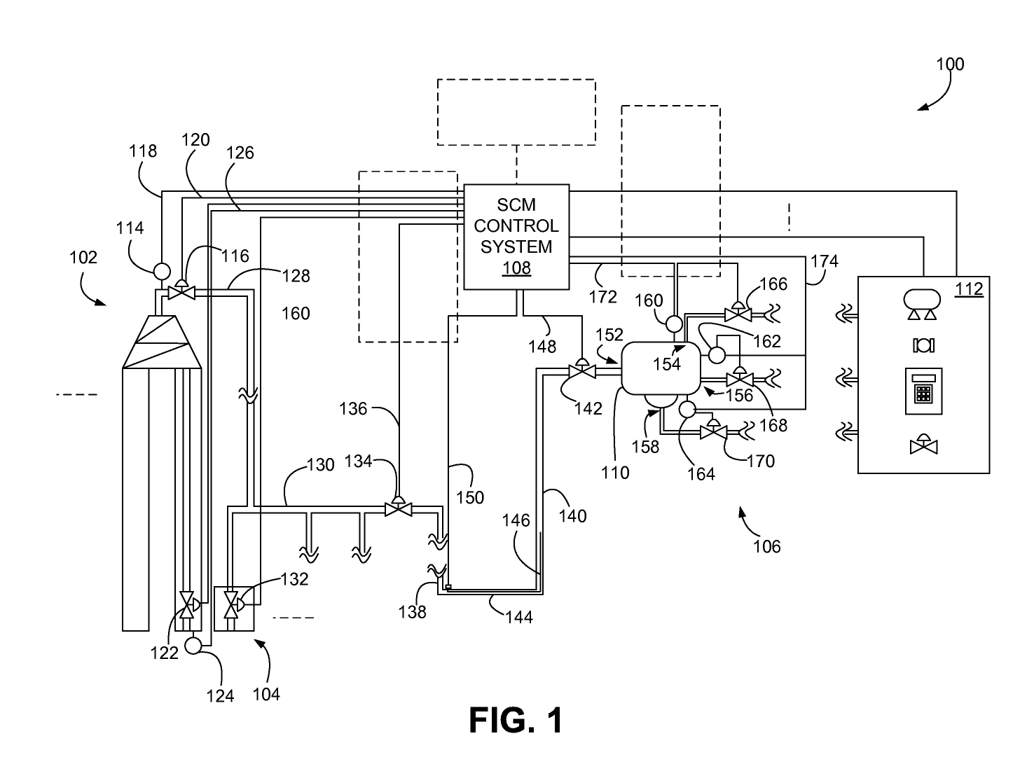

Before describing the various components illustrated in FIG. 1, it should be appreciated within the context of the present disclosure that, though certain embodiments of SCM systems may be quite complex, there are also implementations where SCM system embodiments are much less complex. For instance, one embodiment of an SCM system may merely rely on slug control through actuation of a control valve at a location upstream of a multi-phase separator, the slug control based on input from a multi-point or distributed sensor conveying slug attribute information. In other words, the knowledge of the slug attribute information is a basis for the underlying control employed by the SCM control system. As another example, an embodiment of an SCM system may rely exclusively on slug mitigation through actuation of downstream controls (e.g., downstream of a multi-phase separator) based on the slug attribute information received via a multi-point or distributed sensor. As is clear from the below description, a range of complexity and involvement of controls and sensors are contemplated to be within the scope of the disclosure.

FIG. 1 illustrates an example fluid processing system 100 (also referred to herein as a fluid processing environment) in which certain embodiments of SCM systems may be employed. The fluid processing system 100 may comprise a fluid distribution system and/or a fluid containment system. It should be understood by one having ordinary skill in the art, in the context of the present disclosure, that the fluid processing system 100 shown in FIG. 1 is merely illustrative, and should not be construed as implying any limitations upon the scope of the disclosure. The example fluid processing system 100 comprises one or more well platforms 102 (one is shown). Such a well platform 102 may be part of a field of wells that are co-located in a given area, or distributed among a plurality of areas that are (at least in part) remotely located from one another. The example fluid processing system 100 further comprises one or more subsea (not platform-based) wells 104 (one is shown) and a topsides facility 106. The topsides facility 106 comprises an SCM control system 108 and one or more multi-phase separators 110 (one shown). The example fluid processing system 100 further comprises a downstream sub-system 112. The downstream sub-system 112 comprises equipment located downstream of the multi-phase separator 110, and includes control devices (illustrated in part in FIG. 1) such as pumps, compressors, variable speed drives, control valves, among other components such as multi-phase separators.

It should be understood by one having ordinary skill in the art that the various components of the fluid processing system 100 illustrated in FIG. 1, and the distances or elevations relative to one another, are not to scale. Additionally, though some components are illustrated as having a topsides facility locale (e.g., the separator, SCM control system 108, equipment 112), it should be appreciated that in some embodiments, one or more of such components may be located elsewhere, such as in a subsea locale. Also, note that the use of single, dashed lines in FIG. 1 are used to represent that multiple units or systems or communication mechanisms, as applicable, are contemplated to be within the scope of the disclosure, though additional and/or other components may be included without said representation in some implementations. Further, though illustrated in the context of off-shore facilities, the fluid processing system 100 may be embodied as one or more offshore facilities, one or more onshore facilities, or a combination of both in some embodiments.

Having described generally certain component parts of the example fluid processing system 100, attention is directed to an embodiment of an SCM system that incorporates the SCM control system 108 and a plurality of control devices and sensing systems. In particular, attention is directed proximally to the well platform 102, which has associated with it a pressure transmitter (PT) 114 (also referred to herein as a sensor) and a control device embodied as a wellhead control valve 116 located in one embodiment at the surface of the well platform 102. The control valves described herein may be configured as choke valves, among other adjustable, flow regulating valves, having an associated actuator that, when actuated (e.g., by signaling sent directly or indirectly from the SCM control system 108), causes the valve opening position to be situated (e.g., for a defined amount of time, such as until receiving another signal from the SCM control system 108) to one of a plurality of valve-opening positions ranging between, and including, a fully closed and fully opened position. Note that in some embodiments, additional and/or different sensors than those illustrated in FIG. 1 may be used. For instance, with regard to the well platform 102 as an illustrative, non-limiting example, a temperature sensor (e.g., with transmitter functionality for providing a parameter, such as temperature) may be used at the well platform 102 and/or one or more sensors (single-point, multi-point, and/or distributed) for sensing casing pressure, downhole pressure, flow (e.g., via a flowmeter) among other sensors and/or parameters.

The pressure transmitter 114 communicates via connection 118 to SCM control system 108 a parameter (e.g., pressure) corresponding to the fluid exiting the well, the SCM control system 108 processing the pressure information for use in implementing a given control strategy. Further, the wellhead control valve 116 receives control signals over connection 120 from the SCM control system 108, as described further below. Communications over connections 118 and 120, among other connections between the SCM control system 100 and other components of the fluid processing system 100, are illustrated (at least in part) as occurring over a wired medium. Such communications may be implemented according to any one or more of a plurality of protocols or methods, including but not limited to 4-20 mA control, or via one or a combination of communication protocols such as ModBus, ProfiBus, Ethernet, IP/TCP, among other communication protocols. Further, though illustrated as signaling via a wired media, it should be understood that certain embodiments may incorporate wireless methods of communications, or a combination of wired and wireless communications, including radio frequency (RF), optical communications, among others.

The well platform 102 further may have associated with it a downhole (e.g., subsurface) control valve 122 and/or a pressure transmitter (PT) 124 proximal to the bottom of the well. The PT transmitter 124 may communicate downhole fluid pressure information to the SCM control system 108 via connection 126. The downhole control valve 122 receives signaling from the SCM control system 108 via a wired (not shown) or wireless medium.

Further associated with the well platform 102 is a piping manifold 128 that couples to other well platforms (not shown), and/or to an optional subsea manifold 130. Coupled to the subsea manifold 130 are one or more of the subsea wells 104. Similar to the wells of the platform well 102, one or more of the subsea wells 104 may be equipped with a downhole control valve 132 and/or one or more sensors, such as a pressure transmitter, temperature sensor, flow sensor, etc., that are in communication with the SCM control system 108 in similar fashion to the communications mechanisms described above. The subsea manifold 130 comprises a subsea control valve 134 communicatively coupled to the SCM control system 108 over connection 136.

Upstream of the topsides facility 106, fluid flow from the subsea manifold 130 may flow through optional risers 138 and 140 and piping 144 to a topsides control valve 142 located in one embodiment at or proximal to the topsides facility 106. The piping 144, illustrated in between risers 138 and 140 for illustrative purposes, comprises a distributed sensing system 146 coupled (directly as shown, or indirectly in some embodiments) to the piping 144. The distributed sensing system 146 is optionally coupled to the riser 138 and/or 140 (shown as coupled to riser 140). Note that reference to “coupled to” in association with the distributed sensing system 146 contemplates direct connection to the piping 144 (and optionally riser 140) or placement in proximity to (but not in direct contact with) the piping 144, such as the case for acoustic sensing, explained further below. In some embodiments, the distributed sensing system 146 may be placed in additional locations of the fluid processing system 100, or placed elsewhere in lieu of the current illustrated placement. Further, though described as a distributed sensing system 100, in some embodiments, a multi-point sensing system may be used in lieu of, or in addition to, the distributed sensing system 146 at one or more locations of the fluid processing system 100. For instance, a multi-point sensing system may be configured in one embodiment as a single fiber comprising multiple, discrete sensors, or in some embodiments, as discrete and separate (e.g., not on the same fiber) sensing components linked together (or wired separately) for communication to and from the SCM control system 108 in some embodiments. In one embodiment, each sensor of the multi-point sensing system may communicate individually back to the SCM control system 108, or in some embodiments, communicate in peer-to-peer fashion with a single point of communications between the SCM control system 108 and the multi-point sensing system.

The topsides control valve 142 is communicatively coupled to the SCM control system 108 via connection 148. In some embodiments, this coupling between the SCM control system 108 and the topsides control valve 142 may be implemented through an intermediate device. The distributed sensing system 146 is configured to communicate slug attribute information to the SCM control system 108 via connection 150.

The topsides facility 106 comprises the multi-phase separator 110 located, in one embodiment, downstream of the topsides control valve 142. The multi-phase separator 110 serves to separate gas from liquids and/or liquids from liquids. The multi-phase separator 110 comprises an inlet 152 coupled to the outlet of the topsides control valve 142, and further includes multiple outlets, including two or more of outlets 154 (e.g., gas outlet), 156 (e.g., liquid outlet, such as a hydrocarbon-based liquid like oil), and 158 (e.g., liquid outlet, such as an aqueous-based liquid like water); the quantity of outlets depending on whether the separator 110 operates as a slug catcher (two-phase) or separator (three-phase). For instance, for two-phase separation (e.g., gas and liquid, such as liquid water or liquid hydrocarbon), two of the outlets 154 and 156 are utilized. For three-phase separation, three of the outlets 154, 156, and 158 are utilized. In some embodiments, both a slug catcher and separator may be used in combination (e.g., in series from two-phase slug catcher to three-phase separator and/or in parallel of the aforementioned series configuration and/or as separate units in each branch). As indicated above, one or more multi-phase separators 110 may be located, in part or in whole, in one or more locations including subsea.

Assuming three phase separation for purposes of illustration, the multi-phase separator 110 comprises a plurality of controllers with sensing capability coupled thereto, including without limitation a pressure controller (PC) 160, and two level controllers (LC) 162 and 164 that sense gas pressure and liquid level, respectively, and that further provide signaling based on signaling from the SCM control system 108. Though illustrated with single point functionality, it should be appreciated that in some embodiments, multi-point or distributed sensing capability for one or more of the controllers 160, 162, or 164 is contemplated. Further coupled to outlet piping connected to outlets 154, 156, and 158 are outlet control valves 166, 168, and 170, respectively. In some embodiments, outlet control valves 166, 168, and 170 may be substituted by other types of control devices, such as pumps including variable speed. The outlet control valves 166, 168, and 170, in the illustrated embodiment, receive control signaling from the controllers (e.g., PC 160 and LCs 162 and 164) which may, in certain cases, be based on signaling received by the controllers 160, 162, 164 from the SCM control system 108 that affect respective set-points of the controllers. In some embodiments, the controllers 160, 162, and 164 may be replaced with sensors that provide feedback signaling (e.g., prompted or polled by the SCM control system 108 or automatically) and rely on direct actuation of their associated control valves 166, 168, and 170 by the SCM control system 108.

In the SCM system embodiment illustrated in FIG. 1, the pressure controller 160 is communicatively coupled to the SCM control system 108 via connection 172. In operation, the pressure controller 160 communicates the pressure of the gas sensed in the multi-phase separator 110, and communicates the sensed pressure over connection 172. In one embodiment, the SCM control system 108 communicates set-point information to the pressure controller 160 via connection 172 (though in some embodiments, communications between the SCM control system 108 and the pressure controller 160 may occur on separate connections depending on the direction of information flow). The pressure controller 160 in turn delivers control signals to the associated outlet control valve 166 to adjust the opening of the valve (e.g., adjust valve positioning). Such valve positioning, though directed by virtue of control signals from the pressure controller 160, is based on set-points delivered to the pressure controller 160 by the SCM control system 108 after consideration of slug attribute information conveyed by distributed sensing system 146, among other information.

In a similar control arrangement, feedback of liquid levels from level controllers 162 and 164 are communicated to the SCM control system 108 via connection 174 (though a separate connection may be utilized in some embodiments), and responsive to such respective single point sensing information and further based on slug attribute information, the SCM control system 108 may communicate respective set-points via connection 174 to level controllers 162 and 164. The level controllers 162 and 164, in turn, communicate valve position control signals to associated outlet control valves 168 and 170, respectively. Outlet control valves 168 and 170 may correspond to the separated liquids, such as an aqueous-based fluid (e.g., water) and hydrocarbon-based fluid (e.g., oil).

Note that communication between the controllers 160, 162, 164, the SCM control system 108, and the outlet control valves 166, 168, and 170 may occur according to methods described herein, including 4-20 mA signals, among one or more communication protocols, wired or wireless, bi-directional, uni-directional, etc. Further, the SCM control system 108 may deliver control signals to a select valve, or concurrently to a plurality of select valves. In some embodiments, control signals may be delivered to the various control devices and/or controllers in broadcast fashion, such as in catastrophic scenarios (e.g., emergency shut-down), among other scenarios.

Although the above-described control arrangement for the multi-phase separator 110 provides for relaying control signals between the controllers 160, 162, and 164 and their respective outlet control valves 166, 168, and 170, it should be appreciated in the context of the present disclosure that other control arrangements may be implemented. For instance, in some embodiments, the sensor information (e.g., the parameter information, such as pressure or liquid level parameters) from each of the controllers 160, 162, and 164 (or respective sensors without control functionality) may be communicated to the SCM control system 108, and the control system 108 may communicate set-points directly to the respective control valves 166, 168, and 170 (e.g., bypassing the need for communications between the control valves and the sensors/controllers). Further, though the controllers 160, 162, and 164 are described as utilizing single point sensor functionality, it should be appreciated that in some embodiments, distributed or multi-point sensing may be employed for detecting parameters (e.g., pressure, level, temperature, flow) of the fluid processing system 100. In some embodiments, slug attribute information may be used as control points and the SCM control system 108 configures the controllers (e.g., 160, 162, and/or 164) based on a slug parameter (e.g., volume) and delivers the set-points directly to the desired controller or controllers. The SCM control system 108 may deliver control information to controllers or directly to control devices or to both. Note that the examples described herein contemplate consideration by the SCM control system 108 of other sensed information in addition to the slug attribute information when implementing a given control scheme, though some embodiments may rely exclusively on the slug attribute information in implementing a given control scheme.

The fluid processing system 100 further comprises the downstream equipment 112 (e.g., downstream of the multi-phase separator 110) coupled to the outlet control valves 166, 168, and/or 170. The downstream equipment 112 includes pumps, compressors, variable speed drives, multi-phase separators, and associated control valves and sensors for which communications are exchanged between the SCM control system 108 and the controls and/or sensors in similar manner to the methods and/or arrangements described above. For instance, the outlet of the control valve 166 may be coupled to a compressor, and the outlets of the control valves 168 and 170 may be coupled to respective pumps or another multi-phase separator. As indicated above, one or more of the components of the downstream equipment may be located elsewhere, such as in a subsea locale.

It should be understood that, though a central SCM control system 108 is illustrated as receiving and sending communications directly to the various system components, in some embodiments, additional control equipment or logic (e.g., SCADA system, PLC controllers, etc.) may be used. For instance, as represented by the optional dashed boxes located at different sides of the SCM control system 108, the SCM control system 108 may receive signaling from one or more sensors (single and multi-point or distributed) through an intermediate control system apparatus that interprets, translates, and/or otherwise pre-processes the sensor information before communicating the processed information to the SCM control system 108. Similarly, the SCM control system 108 may communicate control set-points or other controlling parameters or instructions to the control devices through the same or a different intermediate control system. For instance, the SCM control system 108 may provide information upstream in a control hierarchy to another control system for further processing and/or for display and/or monitoring. In some embodiments, the functionality of the SCM control system 108 may be distributed among plural, disparately located components.

Having described the select components of the fluid processing system 100, attention is now directed to an embodiment of an SCM system that comprises one or more of the control devices (e.g., control valves), the distributed (or multi-point) sensing system, the sensors, and the SCM control system 108. Depending on the received slug attribute information obtained from the distributed sensing system 146, different levels of control (e.g., control schemes) may ultimately be implemented by certain embodiments of the SCM system (e.g., through the SCM control system 108). In the description that follows, various control schemes are provided that may implement one or more of slug control, slug mitigation, and/or expanded variations of both. However, there is no hierarchy or order (e.g., no priority order), expressed or implied, by the discussion of these different schemes. In other words, the decision by the SCM control system 108 as to which type or types of control (e.g., slug control, slug mitigation, expanded slug control, expanded slug mitigation) to employ is a dynamic process that adapts the manner of control based on the received slug attribute information and in some implementations other sensor information. Generally, the manner of control employed by the SCM control system 108 depends on the slug attribute information and the availability of control devices that best achieve the slug control or mitigation.

In one (e.g., a first) control scheme, the SCM control system 108, based on the received slug attribute information from the distributed sensing system 146 and sensor information throughout the fluid processing system 100 (e.g., from 114, 124, 160, 162, 164, and like components in the downstream sub-system 112) and processing of the information, the SCM control system 108 may determine that only slug control is warranted. Accordingly, in one implementation, the SCM control system 108 receives slug attribute information from the distributed sensing system 146, such as the size and speed (and possibly location, direction, etc.) that a slug is approaching from upstream of the topsides control valve 142, and delivers a control signal to the topsides control valve 142 to effect (cause) an altering or modification of the valve position (hence throttling flow therethrough) of the topsides control valve 142. For instance, a control signal conveyed from the SCM control system 108 (e.g., based on the received slug attribute information) to the topsides control valve 142 may effect a reduction in valve opening, resulting in a reduction or elimination of the slug up to a defined minimum valve position. In some embodiments, an intermediary control loop may be employed where the slug control scheme activates the intermediary control loop and determines a set-point for it.

In another example, if a slug is large enough where a slug mitigation technique such as capacity control alone is not sufficient to suitably accommodate (e.g., where an upset of downstream equipment is likely) the influx of fluid, the SCM control system 108 may decide to implement a more aggressive throttling (e.g., choking) of the topsides control valve 142. Note that, though a first control scheme is implemented (e.g., slug control), consideration of information from other components (e.g., in this example, from the capacity control components) is still employed before deciding on a given control scheme. Also, it is noted that slug behavior is dynamic, at one instant the slug being present in the fluid processing system 100, and at other instances, dissipated or worse, accumulated by combining with another slug. Accordingly, the feedback of behavior of the slug and processing system is dynamically received by the SCM control system 108 from the distributed sensing system 146 and may result in dynamically changing the control configuration (scheme) applied.

As yet another example, the SCM control system 108 may receive slug attribute information that conveys that the location of the slug is at one of the wells (e.g., of the platform 102). Based on the location information of the slug (and possibly other slug attribute information and/or other sensing information from other parts of the system 100), the SCM control system 108 may decide that slug control at the well serves to best achieve the goals of the system 100, and hence signals the downhole control valve 122 to actuate, eliminating the slug at its source. As mentioned in a previous example, some SCM system embodiments may activate an intermediary control loop, and assign a set-point to said controller.

In another (e.g., a second) control scheme, the control signal delivered by the SCM control system 108 causes slug control according to the first control scheme (e.g., slug control) and slug mitigation. For instance, through receipt and processing of the slug attribute and sensor information from respective components throughout the fluid processing system 100, the SCM control system 108 determines that slug control via the topsides control valve 142 (e.g., first control scheme) and slug mitigation (e.g., capacity control) via involvement of the pressure controller 160 in cooperation with the associated outlet control valve 166 and the level controllers 162 and 164 in cooperation with the associated outlet control valves 168 and 170 is warranted, and hence signals to these components accordingly. In other words, the SCM control system 108 provides a balance of slug control with capacity control, either through concurrent signaling to all components involved with the second level of slug control and slug mitigation, or serially delivered to select components (e.g., either sent to slug control components or slug mitigation component, and then after a suitable delay based on a fixed delay or feedback from the distributed, multi-point, or other sensors, sent to the other slug countermeasure components).

In one embodiment, slug mitigation in the form of capacity control is exercised in an arrangement including the outlet control valves 166, 168, and 170, the pressure controller 160 and level controllers 162, 164, and the SCM control system 108 in combination with slug attribute information to automatically alter available separator volume in time to handle additional incoming fluid flow at the inlet 152 due to the presence of a slug in the system 100 upstream of the multi-phase separator 110. As previously described, the distributed sensing system 146 provides dynamic information about the slug, enabling an adaptable control that may be modified in real-time or near real-time based on the most current information about the slug. Advance notice of slug arrival is provided via the slug attribute information conveyed to the SCM control system 108, enabling (via communication by the SCM control system 108) smooth changes in operating points (e.g., set-points to the pressure controller 160 and level controllers 162 and 164) and potentially to downstream equipment controls, as well (and in turn communication to the respective outlet control valves 166, 168, and 170) associated with the multi-phase separator 110 and reducing the potential for upset (e.g., causing wear and tear) of the downstream sub-system components.

As an example of the second control scheme, capacity control in combination with a moderate reduction in opening of the topsides control valve 142 may be implemented by the SCM control system 108 (in combination with the requisite components as described above) to reduce slugging to a level where capacity in the multi-phase separator 110 is sufficient to accommodate the slugging behavior.

As another example of the second control scheme, the slug attribute information received by the SCM control system 108 indicates that the slug is deemed large enough to initially require significant choking of the topsides control valve 142. Such an action may cause a significant reduction in the size of the slug, enabling the capacity controls to be applied to handle the reduced size slug without a further reduction in the opening of the topsides control valve 142 or possibly even allowing this valve 142 to be opened somewhat.

In yet another (e.g., third) control scheme, the first and second control schemes described above are implemented along with expanded (e.g., expanded to other control devices) mitigation control through signaling between the SCM control system 108 and the control and sensing devices of the downstream sub-system 112. As indicated above, the downstream sub-system 112, which in some embodiments may be a part of the topsides facility 106, may include multiple separators, pumps, variable speed drives, control valves, and/or compressors of variable capacity that each act as a control device. The SCM control system 108 may determine that the combined actions of the components from the first and second control schemes and the downstream sub-system 112 are required and signal to each of these concurrently or serially as needed, possibly maximizing flexibility and responsiveness of the capacity controls.

In a fourth control scheme, the SCM system utilizes the first, second, and third control schemes in conjunction with control of the upstream control devices and sensors, such as the wellhead control valve 116 and pressure transmitter 114, the downhole control valve 122 and optionally the pressure transmitter 124, and the subsea control valve 134, based on consideration from information received from the entire fluid processing system 100. In other words, though receipt and consideration of information by the SCM control system 108 is dealt with in a global manner (e.g., receives all slug attribute and sensor information from the entire system 100), certain embodiments of the SCM system provide a completely global approach to actuated control, where in addition to control of the topsides control valve 142 (slug control), the outlet control valves 166, 168, 170 and controllers 160, 162, 164 (slug mitigation), and the expanded mitigation control associated with the downstream sub-system 112, the SCM control system 108 further provides expanded slug control signaling to wellhead control valve(s) 116, downhole control valves 122, and/or subsea control valves 134.

Signaling to a plurality of these aforementioned control devices may be implemented concurrently, or serially, or a combination of both. Further, as an example, if there are plural wellhead control valves 116 (or downhole control valves 122 in some implementations, or subsea, or all of these), the SCM control system 108 may be selective (e.g., intelligent) in its signal destination. In other words, the distributed sensing system 146 may be used to pinpoint the location where the slug is generated (e.g., based on received slug attribute information corresponding to speed, location, and/or direction), and if a particular well is causing the slugging, its corresponding wellhead control valve 116 (or downhole control valve 122) may be used (e.g., as actuated by the SCM control system 108 based on the attribute information) to control the slug.

Note that in some embodiments, a similar, intelligent selection may be utilized by the SCM control system 108 in association with the other sensors (e.g., non-slug attribute conveying sensors). Slug control is conventionally done as pressure and/or flow control to a valve (e.g., at the separator inlet, subsea, wellhead, etc.). Generally, the conventional control scheme uses a valve to control pressure or flow that is in proximity to the measurement (e.g., for pressure, downstream of the measurement). The SCM may chose to use control loop(s) based upon single-point sensors to implement slug control. However, the most appropriate single-point sensor(s) is selected from among those available for use in the control loop(s). In a similar manner to the control valve selection explained above, the sensor information may be used by the SCM control system 108 to determine which control variable/point of those available is most appropriate for use in a given control scheme. In some embodiments, as indicated previously, the SCM control system 108 determines valve output directly, instead of setting the set-point of a single-point sensor control loop. Since the real-time slug attribute behavior can be monitored with the sensors, this information may be used to assist in dynamic determination of the correct control configuration (i.e. control scheme, tuning, set-points, etc.). As the source, frequency, size, etc. of slugs and flow rates can change over the life of the fluid processing system 100, these selections (e.g., of control parameter(s) and set-points) are dynamic (e.g., determined set-points may be re-adjusted one or more times for optimal performance based on system conditions).

One having ordinary skill in the art should understand, in the context of the present disclosure, that variations to one or more of the control schemes and the corresponding components involved are contemplated to be within the scope of the disclosure. For instance, though the first control scheme is illustrated as implemented exclusively as slug control as a base control, the base control may be implemented differently in some embodiments. In other words, the second control scheme adds slug mitigation to slug control, but in some embodiments, this implementation may be reversed or other components of the fluid processing system 100 may be used as the base control. As one example of such a variation, if a slug is deemed (e.g., by the SCM control system 108) adequately handled by slug mitigation via capacity control, then there is no need to activate slug control. In other words, there is no need for altering, via a control signal from the SCM control system 108, the valve opening position of the topsides control valve 142, nor any other valve to control the slug (could be any of the available valves). Accordingly, a variation of the first control scheme may be embodied as slug mitigation as the base control instead of slug control as the base control. One benefit of such a determination by the SCM control system 108 is that there is no choking of the topsides control valve 142 or other slug control valve. Or, if slugging is coming from a single well, then expanded slug control at that well may handle the problem and slug control at the inlet to the separator may not be needed.

Note that in implementations with plural types of wells (e.g., plural platform-based wells, subsea wells, etc.), the associated sensors and controls may mirror the single well descriptions of each type described for, and illustrated in, FIG. 1. Also noteworthy is that variations in the control architecture or fluid processing environment are also contemplated to be within the scope of the disclosure. For instance, some embodiments of a fluid processing system may omit certain components, whereas some embodiments may add additional components not shown. In addition, known components, such as flanges or other piping components are omitted for purposes of facilitating an understanding of certain embodiments of the disclosed SCM systems. The control architecture may include in some embodiments transmitters for one or more of the control valves, such as to provide feedback to the SCM control system 108 as to valve position for a given valve. Further, though pressure, level, and temperature sensors have been described, other sensors may be included in some embodiments of the fluid processing system 100, including those for sensing fluid flow rate, density measurements, differential pressure, and speed, among others known to those having ordinary skill in the art.

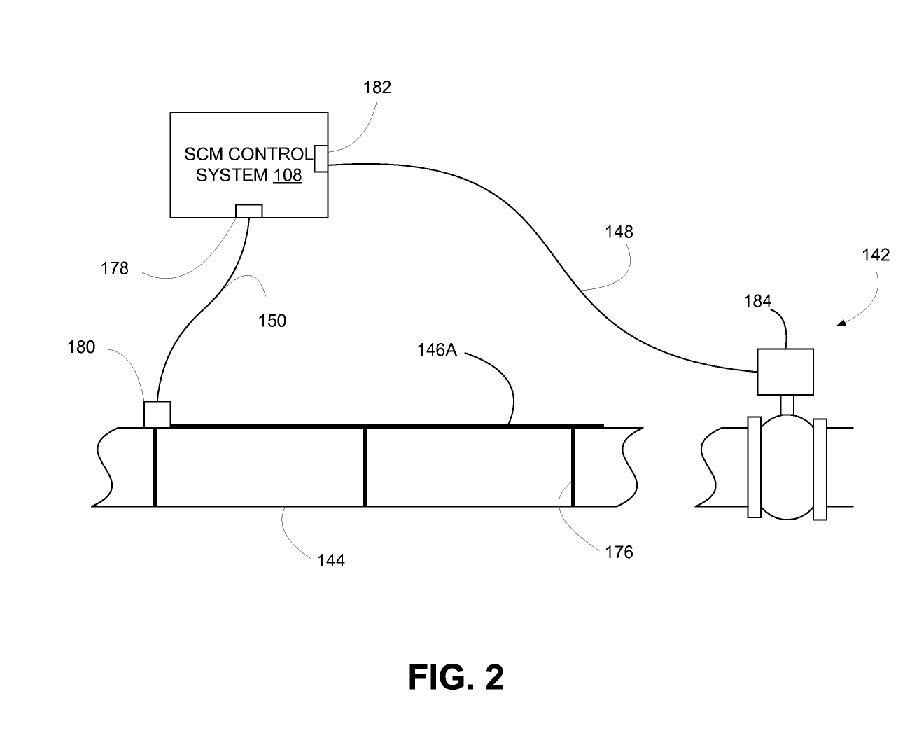

Having described an embodiment of the fluid processing system 100 and SCM control system 108 utilized therein, attention is directed to FIG. 2, which illustrates one configuration of the example distributed sensing system 146 shown in FIG. 1. As shown, the SCM control system 108 is coupled (e.g., connected directly in the illustrated embodiment) to the distributed sensing system 146A. The distributed sensing system 146A is attached to the piping 144 via known attachment means 176 (e.g., cable ties, metal hose clamps, etc.) and run, in one embodiment, in a linear fashion along the top of the piping 144. In some embodiments, the distributed sensing system 146A may be run linearly elsewhere on the piping (e.g., other than at the top), wound around the piping 144, spiraled at the top, or in some embodiments, separated from the piping 144 a distance D, such that the distributed sensing system 146A is not in direct contact with the piping 144 yet close enough to be influenced by the fluid flow through the piping 144. As indicated above, the distributed sensing system 146A may also be run in similar manner along a riser. In some embodiments, the distributed sensing system 146A may be run downhole.

In one embodiment, the distributed sensing system 146A comprises a distributed or multi-point acoustic (e.g., passive) sensor. As indicated above, the multi-point sensor may be embodied as a single fiber (e.g., of similar appearance to that shown in FIG. 2) embedded with discrete sensors (e.g., not continuous) along the length of the fiber, or in some embodiments, as discrete components that are communicatively coupled in a peer-to-peer arrangement or individually coupled to the SCM control system 108. In some embodiments, other distributed or multi-point based sensors may be used, including those based on density, weight, conductivity, conductance, impedance, resistance, capacitance, refractive index, pressure (including differential pressure), ultrasonic, and nuclear. Further, where more than one distributed or multi-point system are used in a fluid processing system 100, one or more of these types of technologies for the distributed or multi-point sensing system may be utilized.

The SCM control system 108 comprises a communications interface or port 178 to couple the connection 150 arising from an enclosure 180 of the distributed sensing system 146A (e.g., where the cabling of the connection 150 splices or otherwise connects to the wiring of the distributed sensing system 146A) to the internal SCM control circuitry. The SCM control system 108 further comprises a second communications interface 182 to deliver control signals via connector 148 from the SCM control system 108 to an actuator 184 of the control valve 142. Note that the interfaces 178 and 182 are suitable for the given communication protocol and/or connection medium, and in some embodiments, one or both may be configured for wireless communications. Further, though described as separate interfaces, in some embodiments, functionality of both interfaces 178 and 182 may be combined in a single interface, or distributed among additional interfaces. Also, though illustrated in FIG. 2 as respective uni-directional interfaces 178 and 182, it should be appreciated that one or more of the interfaces 178 and 182 may be configured for bi-directional communication in some embodiments. It should be appreciated that the interfaces 178 and/or 182 (or in some embodiments, additional, like-configured interfaces) may be utilized for communication with other devices, such as for receiving sensor information (e.g., for single-point sensors) via interface 178 and communication of set-points or other information or data to controllers or other devices via interface 182.

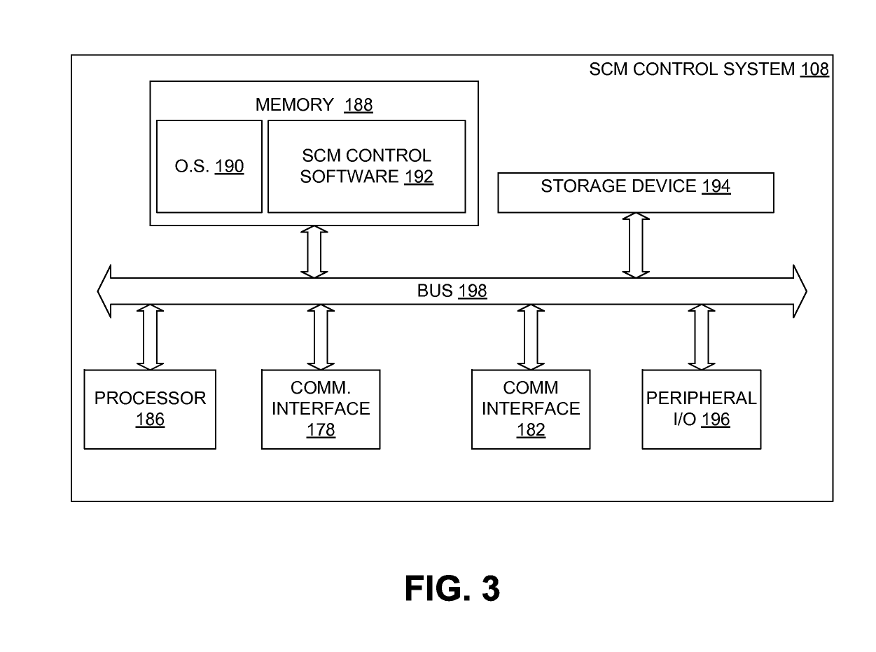

Having described certain features of the fluid processing system 100 and the distributed sensing system 146 (including 146A), attention is directed to an embodiment of the SCM control system 108 as embodied as a computing device as shown in FIG. 3. It should be understood that the SCM control system 108 may be embodied with fewer and/or different components in some embodiments, and hence the SCM control system 108 illustrated in FIG. 3 is for illustrative, non-limiting purposes. In the illustrated embodiment shown in FIG. 3, the SCM control system 108 contains a number of components that are well-known in the computer arts, including a processor 186, memory 188, an optional operating system (O.S.) 190 stored in memory 188, a storage device 194, a peripheral I/O interface 196, and one or more busses (one shown, illustrated as bus 198). The peripheral I/O interface 196 provides for input and output signals, for example, user inputs from a mouse or keyboard, and outputs for connections to a printer or display device (e.g., computer monitor) or externally coupled storage. The SCM control system 108 further comprises SCM control software 192 encoded on a computer readable medium (e.g., non-volatile and/or volatile) and executed by the processor 186.

In the illustrated embodiment, the computer readable medium on which the software 190 and 192 are encoded comprises the memory 188, though in some embodiments, the software 190 and/or 192 may be encoded in the storage device 194 (e.g., optical or magnetic disc, or in some embodiments, semiconductor-based). In some embodiments, the storage device 194 may be omitted. As indicated above, memory 188 also optionally includes the O.S. 190, which controls operations among the SCM control system components. The SCM control system 108 further comprises communication interfaces 178 and 182, as described previously, which may be configured as uni-directional, bi-directional, or a combination of both, for wireless and/or wired mediums. The aforementioned components are coupled via the one or more busses 198 (one shown). Omitted from FIG. 3 are a number of conventional components that are unnecessary to explain the operation of the SCM control system 108.

In one embodiment, the SCM control software 192 is embodied as software and/or firmware (e.g., executable instructions) encoded on a tangible (e.g., non-transitory) computer readable medium such as memory 188 and executed by the processor 186 under the auspices of the operating system 190. The SCM control software 192 carries out the interpretations of the sensed data and monitoring of available control devices and sensors, and provides the determinations of proper control configuration to employ based on the received slug attribute information and other sensor information. The SCM control software 192 further effects the control signaling (e.g., set-point adjustment, control valve opening position, variable speed control, on/off switching, etc.) from the interface 182. As indicated above, the actuation of control devices and/or reception of information may be implemented through one or more intermediate devices. Note that the computer readable medium may include technology based on electronic, magnetic, optical, electromagnetic, infrared, or semiconductor technology. Further note that functionality of the SCM control software 192 may be further distributed among separate but cooperating software modules and/or devices.

In some embodiments, functionality associated with the SCM control software 192, in whole or in part, may be implemented in hardware logic. Hardware implementations include, but are not limited to, a programmable logic device (PLD), a programmable gate array (PGA), a field programmable gate array (FPGA), an application-specific integrated circuit (ASIC), a system on chip (SoC), and a system in package (SiP). In some embodiments, one or more functionality associated with the SCM control software 192 may be implemented as a combination of hardware logic and processor-executable instructions (software and/or firmware logic). It should be understood by one having ordinary skill in the art, in the context of the present disclosure, that in some embodiments, one or more functionality of the SCM control software 192 may be distributed among several devices, co-located or located remote from each other.

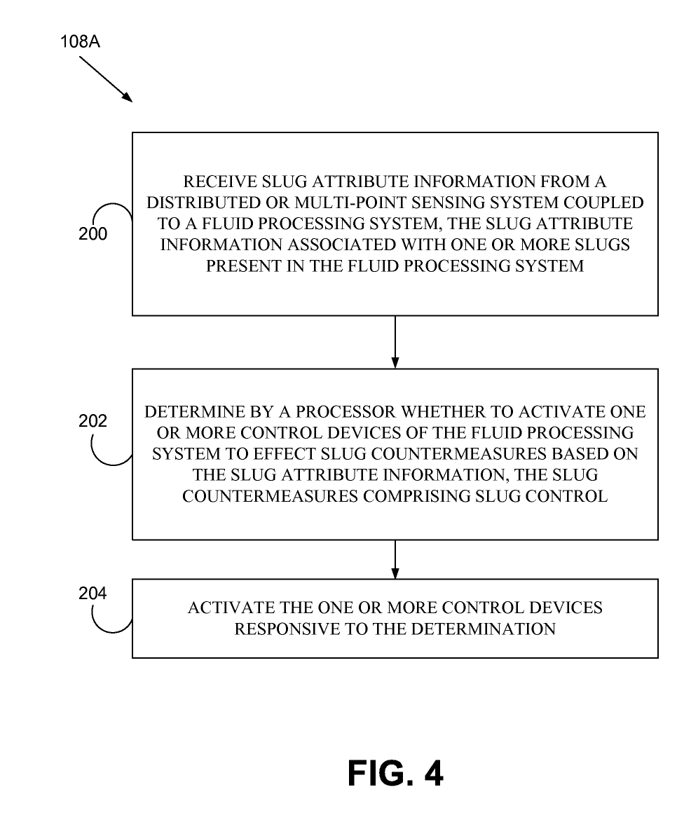

Having described certain embodiments of the SCM systems, it should be appreciated, in the context of the present disclosure, that one embodiment of a method 108A, illustrated in FIG. 4 and implemented by the SCM control system 108 (e.g., via processor 186 (or other processor) executing the SCM control software 192) comprises receiving slug attribute information from a distributed or multi-point sensing system coupled to a fluid processing system, the slug attribute information associated with one or more slugs present in the fluid processing system (200); determining by a processor whether to activate one or more control devices of the fluid processing system to effect slug countermeasures based on the slug attribute information, the slug countermeasures comprising slug control (202); and activating (e.g., directly or indirectly through an intermediate device(s) or both) the one or more control devices responsive to the determination (204).

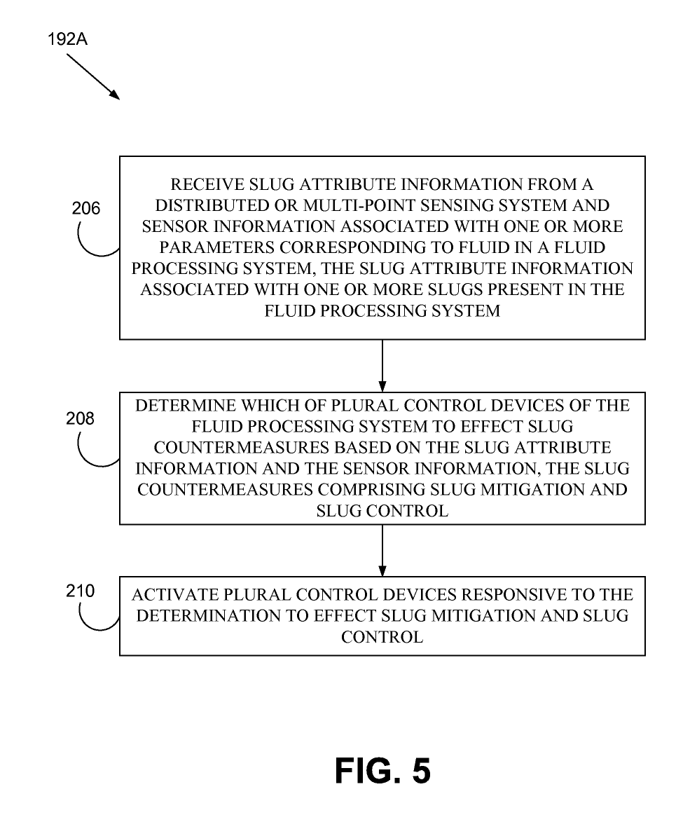

It should be appreciated in the context of the present disclosure that another method embodiment 192A, illustrated in FIG. 5 and implemented by a processor (e.g., processor 186) executing the SCM control software 192 stored on a computer readable medium comprises receiving slug attribute information from a distributed or multi-point sensing system and sensor information associated with one or more parameters corresponding to fluid in a fluid processing system, the slug attribute information associated with one or more slugs present in the fluid processing system (206); determining which of plural control devices of the fluid processing system to effect slug countermeasures based on the slug attribute information and the sensor information, the slug countermeasures comprising slug mitigation and slug control (208); and activating (e.g., directly or indirectly or both) plural control devices responsive to the determination to effect slug mitigation and slug control (210).

Any software components illustrated herein are abstractions chosen to illustrate how functionality may be partitioned among components in some embodiments of the slug countermeasure systems disclosed herein. Other divisions of functionality are also possible, and these other possibilities are intended to be within the scope of this disclosure. To the extent that systems and methods are described in object-oriented terms, there is no requirement that the disclosed systems and methods be implemented in an object-oriented language. Rather, the systems and methods can be implemented in any programming language, and executed on any hardware platform. Any software components referred to herein include executable code that may be packaged, for example, as a standalone executable file, a library, a shared library, a loadable module, a driver, or an assembly, as well as interpreted code that is packaged, for example, as a class.

The flow diagrams herein provide examples of the operation of the slug countermeasure systems and methods. Blocks in these diagrams represent procedures, functions, modules, or portions of code which include one or more executable instructions for implementing logical functions or steps in the process. Alternate implementations are also included within the scope of the disclosure. In these alternate implementations, functions may be executed out of order from that shown or discussed, including substantially concurrently or in reverse order, depending on the functionality involved.

The foregoing description of illustrated embodiments of the present disclosure, including what is described in the abstract, is not intended to be exhaustive or to limit the disclosure to the precise forms disclosed herein. While specific embodiments of, and examples for, the disclosure are described herein for illustrative purposes only, various equivalent modifications are possible within the spirit and scope of the present disclosure, as those skilled in the relevant art will recognize and appreciate. As indicated, these modifications may be made to the present disclosure in light of the foregoing description of illustrated embodiments.

Thus, while the present disclosure has been described herein with reference to particular embodiments thereof, a latitude of modification, various changes and substitutions are intended in the foregoing disclosures, and it will be appreciated that in some instances some features of embodiments of the disclosure will be employed without a corresponding use of other features without departing from the scope of the disclosure. Therefore, many modifications may be made to adapt a particular situation or material to the essential scope of the present disclosure. It is intended that the disclosure not be limited to the particular terms used in following claims and/or to the particular embodiment disclosed as the best mode contemplated for carrying out this disclosure, but that the disclosure will include any and all embodiments and equivalents falling within the scope of the appended claims.

At least the following is claimed:

1. A method, comprising:
receiving slug attribute information from a distributed or multi-point sensing system coupled to a fluid processing system, the slug attribute information associated with one or more slugs present in the fluid processing system;
determining by a processor whether to activate one or more control devices of the fluid processing system to effect slug countermeasures based on the slug attribute information, the slug countermeasures comprising slug control; and
activating the one or more control devices responsive to the determination.

2. The method of claim 1, wherein receiving the slug attribute information comprises receiving information corresponding to one or a combination of slug propagation direction, slug velocity, frequency of slug occurrence, duration of the slug occurrence, slug density, slug composition, or slug volume.

3. The method of claim 2, wherein receiving the slug attribute information further comprises receiving information corresponding to one or more of a combination of slug location, slug temperature, slug length, slug pressure, slug level, or multiphase flow rate.

4. The method of claim 1, wherein receiving the slug attribute information comprises receiving the slug attribute information from a distributed or multi-point sensing system based on one or a combination of the following technologies: acoustic, strain type, density, weight or ultrasonic.

5. The method of claim 1, wherein receiving the slug attribute information comprises receiving the slug attribute information from a distributed or multi-point sensing system based on one or more of the following technologies: conductivity, impedance, resistance, strain, capacitance, refractive index, pressure, or differential pressure.

6. The method of claim 1, wherein the slug countermeasures further comprises a slug mitigation process, further comprising receiving sensor information associated with one or more parameters, the sensor information corresponding to one or a combination of fluid temperature, fluid pressure, fluid flow rate, fluid level, density, composition, differential pressure, pressure, or speed.

7. The method of claim 6, wherein the slug mitigation process comprises one or a combination of adjusting a capacity of one or more multi-phase fluid separators located downstream of the one or more slugs or adjusting operation of equipment located downstream of the one or more multi-phase fluid separators.

8. The method of claim 6, wherein activating the one or more control devices comprises delivering or causing to be delivered a control signal to a processing facility valve or a plurality of processing facility valves.

9. The method of claim 6, wherein activating the one or more control devices comprises delivering or causing to be delivered a control signal to equipment located downstream from a multi-phase fluid separator, the equipment comprising one or more of a pump, variable speed drive, multi-phase separator, a control valve, or a compressor.

10. The method of claim 6, wherein activating the one or more control devices comprises delivering or causing to be delivered a control signal to a control valve located proximally to one or more multi-phase fluid separators.

11. The method of claim 6, wherein activating the one or more control devices comprises delivering or causing to be delivered a control signal to one of a controller located proximally to one or more multi-phase fluid separators, the controller activating an associated control valve, or a control valve.

12. The method of claim 1, wherein the slug control process comprises one or a combination of eliminating the one or more slugs, reducing a size of the one or more slugs, reducing a frequency of occurrence of the one or more slugs, or modifying a duration of the one or more slugs.

13. The method of claim 1, wherein activating the one or more control devices comprises delivering or causing to be delivered a control signal to a subsea control valve or valves disposed between a well and a topsides facility.

14. The method of claim 1, wherein activating the one or more control devices comprises delivering or causing to be delivered a control signal to one or a combination of a suitable wellhead control valve, downhole control valve, or subsea valve selected among a choice of one or a combination of a plurality of wellhead control valves, a plurality of downhole control valves, or a plurality of subsea valves based on the slug attribute information.

15. The method of claim 1, wherein activating the one or more control devices comprises delivering or causing to be delivered a control signal to a downhole control valve disposed in a well.

16. The method of claim 1, wherein activating the one or more control devices comprises delivering or causing to be delivered a control signal to a wellhead control valve disposed proximal to a well platform.

17. A system, comprising:
a memory encoded with software; and
a processor configured to execute the software to:
receive slug attribute information from a distributed or multi-point sensing system and sensor information associated with one or more parameters corresponding to fluid in a fluid processing system, the slug attribute information associated with a slug present in the fluid processing system;
determine which of plural control devices of the fluid processing system to activate to effect one or more slug countermeasures based on the slug attribute information and the sensor information, the slug countermeasures comprising slug mitigation and slug control; and
provide a control signal that activates one or more of the plural control devices responsive to the determination.

18. The system of claim 17, further comprising the distributed or multi-point sensing system, the distributed or multi-point sensing system comprising a passive acoustic sensor.

19. The system of claim 17, further comprising a multi-phase fluid separator having an inlet and plural outlets, the plural control devices embodied as a first control valve proximal to the inlet and plural controllers located proximal to each of the plural outlets, each of the plural controllers controlling an associated control valve, the plural controllers further configured to provide sensor information, the plural controllers comprising a pressure controller electrically coupled to a first associated control valve, and at least one level controller coupled to a second associated control valve.

20. The system of claim 17, wherein the processor is further configured to execute the software to, based on the determination, effect the slug countermeasures by providing the control signal corresponding to a first set of values to the first control valve to adjust a valve opening of the first control valve.

21. The system of claim 17, wherein the processor is further configured to execute the software to, based on the determination, effect the slug countermeasures by providing the control signal corresponding to a second set of values to the plural controllers to adjust one or more settings.

22. The system of claim 17, wherein the processor is further configured to execute the software to, based on the determination, effect the slug countermeasures by both providing the control signal corresponding to a first set of values to a first control valve of the plural control valves to adjust a valve opening of the first control valve located upstream of a multi-phase separator and providing the control signal corresponding to a second set of values to a plurality of controllers located downstream of the multi-phase separator to adjust one or more settings, each of the plural controllers actuating an associated control valve based on the adjusted one or more settings.

23. The system of claim 22, further comprising equipment coupled to the plural control valves, wherein the processor is further configured to execute the software to, based on the determination, effect the slug countermeasures by providing the control signal corresponding to a third set of values to equipment located downstream of the control valves associated with the plural controllers.

24. The system of claim 23, further comprising a plurality of wellhead control valves located proximal to one or more well platforms, wherein the processor is further configured to execute the software to, based on the determination, effect the slug countermeasures by providing the control signal corresponding to a fourth set of values to the plurality of wellhead control valves.

25. The system of claim 24, further comprising a plurality of downhole control valves, each located in a respective one of the wells associated with the one or more well platforms, wherein the processor is further configured to execute the software to, based on the determination, effect the slug countermeasures by providing the control signal corresponding to a fifth set of values to the plurality of downhole control valves.

26. The system of claim 25, further comprising a plurality of subsea control valves, each located between the wells of the well platform and a topsides facility, wherein the processor is further configured to execute the software to, based on the determination, effect the slug countermeasures by providing the control signal corresponding to a sixth set of values to the plurality of subsea control valves.

27. The system of claim 26, wherein providing the control signal comprises providing the control signal concurrently to two or more of each type of control valve or concurrently to plural devices of the equipment.

28. The system of claim 26, wherein providing the control signal comprises providing the control signal concurrently to two or more of the following: the first control valve, the plural controllers, the wellhead control valve, the downhole control valve, the subsea control valve, and a control device of the equipment.

29. A computer readable medium comprising executable software encoded thereon, the software executed by a processor to:
receive slug attribute information from a distributed or multi-point sensing system and sensor information associated with one or more parameters corresponding to fluid in a fluid processing system, the slug attribute information associated with one or more slugs present in the fluid processing system;
determine which of plural control devices of the fluid processing system to effect slug countermeasures based on the slug attribute information and the sensor information, the slug countermeasures comprising slug mitigation and slug control; and
activate plural control devices responsive to the determination to effect slug mitigation and slug control.

30. The computer readable medium of claim 29, wherein the slug countermeasures comprise the processor configured by the software to prohibit or cause to prohibit fluid inflow from exceeding a capacity of a separator or equipment downstream or a combination of both.
